(19) United States
(12) Patent Application Publication
(10) Pub. No.: US 2020/0050707 A1
(43) Pub. Date: Feb. 13, 2020

(54) WEBSITE REPRESENTATION VECTOR

(71) Applicant: Google LLC, Mountain View, CA (US)

(72) Inventor: Yevgen Tsykynovskyy, Stoneham, MA (US)

(21) Appl. No.: 16/100,713

(22) Filed: Aug. 10, 2018

(51) Int. Cl. G06F 17/30; G06N 5/02

(52) U.S. Cl. CPC G06F 17/30917; G06F 17/30663; G06F 17/3069; G06F 17/30693; G06F 17/30867; G06N 5/02

(57) ABSTRACT

Methods, systems, and apparatus, including computer programs encoded on computer storage media, for using website representations to for generate, store, or both, search results. One of the methods includes receiving data representing each website in a first plurality of websites associated with a first knowledge domain of a plurality of knowledge domains and having a first classification; receiving data representing each website in a second plurality of websites associated with the first knowledge domain and having a second classification; generating a first composite-representation of the first plurality of websites; generating a second composite-representation of the second plurality of web sites; receiving a representation of a third website; determining a first difference measure between the first composite-representation and the representation; determining a second difference measure between the second composite-representation and the representation; and based on the first difference measure and the second difference measure, classifying the third website.

### BACKGROUND

This specification relates to classifying and generating web search results.

The Internet provides access to a wide variety of resources, for example, video files, image files, audio files, or Web pages, including content for particular subjects, book articles, or news articles. A search system can select one or more resources in response to receiving a search query. A search query is data that a user submits to a search engine to satisfy the user's informational needs. The search queries are usually in the form of text, e.g., one or more query terms, and may also include transcriptions of spoken search queries. The search system selects and scores resources based on their relevance to the search query and on their importance relative to other resources to provide search results. The search results are typically ordered according to the scores and presented according to this order.

### SUMMARY

In general, one innovative aspect of the subject matter described in this specification can be embodied in methods that include the actions of, for each website of a plurality of websites determined to be in a particular knowledge domain, wherein the particular knowledge domain is one of a plurality of knowledge domains that are each different from the other knowledge domains: receiving representations of the website and a quality score representing a quality measure of the website relative to other websites; classifying as first websites each of the plurality of websites having a quality score below a first threshold, at least one of the plurality of websites having a quality score below the first threshold; classifying as second websites each of the plurality of websites having a quality score above a second threshold that is greater than the first threshold, at least one of the plurality of websites having a quality score greater than the first threshold; generating a first composite-representation of the websites classified as the first websites; generating a second composite-representation of the websites classified as the second websites; receiving a representation of another website; determining a first measure of difference between the first composite-representation and the representation; determining a second measure of difference between the second composite-representation and the representation; and based on the first measure of difference and the second measure of difference, classifying the other website as one the first websites, the second websites, or as third websites that are not classified as either the first websites or second websites. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method may include receiving a query that includes terms that are determined to be indicative of the particular knowledge domain, and in response: selecting one of the second websites for use in responding to the query; and responding to the query using information from the selected second website. The method may include determining, using the terms included in the query, that the query requests responsive data from the particular knowledge domain; and in response to determining that the query requests responsive data from the particular knowledge domain, determining to search the second web sites and to skip searching the first web sites for search results responsive to the query. The second websites may be determined to be a collection of authoritative data sources. The method may include generating, from the collection of authoritative data sources, preprocessed responses to future queries; receiving, after generating the preprocessed responses, a query that is determined to be indicative of the particular knowledge domain; and in response, responding to the query with one of the preprocessed response.

In some implementations, each representation of the websites may be a feature vector derived from the corresponding website. Generating the first composite-representation of the websites classified as the first websites may include generating a first feature vector that is a central tendency of the feature vectors of the websites classified as the first websites. Generating the second composite-representation of the websites classified as the second web sites may include generating a second feature vector that is a central tendency of the feature vectors of the websites classified as the second websites. Determining the first measure of difference may include determining first scalar difference between the first composite-representation and the representation of the other website. Determining the second measure of difference may include determining second scalar difference between the second composite-representation and the representation of the other website. The method may include generating each of the feature vectors using a neural network that receives, as input, content included in a corresponding website. The first feature vector that is a central tendency of the feature vectors of the websites classified as first websites may include a first feature vector that includes averages of the feature vectors of the websites classified as first websites. The second feature vector that is a central tendency of the feature vectors of the websites classified as first websites may include a second feature vector that includes averages of the feature vectors of the websites classified as first websites. The representations for at least some of the plurality of websites may be generated using only proper subsets of a set of resources that belong to the respective website.

The subject matter described in this specification can be implemented in various embodiments and may result in one or more of the following advantages. The systems and methods described in this document may improve computation efficiency, improve generated search results, or both. For instance, a search system may select, search, or both, data for only websites with a particular classification, reducing computer resources necessary to find search results, e.g., by not selecting, searching, or both, any website irrespective of classification. This may reduce the amount of storage required to store data for potential search results, e.g., may require only data storage for websites with the particular classification, may reduce a quantity of websites analyzed by the search system, e.g., limiting a search to only websites with the particular classification, may reduce network bandwidth used to provide search results to a requesting device, or two or more of these. In some examples, the systems and methods described in this document, e.g., that select, search or both, data for only websites with a particular classification, may address potential problems with prior systems, such as higher use of bandwidth, memory, processor cycles, power, or a combination of two or more of these. In some implementations, the systems and methods described in this document may improve search results pages generated by a search system by including identification of only websites with a particular classification, e.g., a qualitative classification, in generated search results pages. By using a composite-representation based upon existing website classifications, the website classification is able to use characteristics learned from existing websites to classify previously unseen websites without requiring user input for the classification. For instance, the systems and methods described in this document can detect websites that are more likely responsive to queries for a knowledge domain, e.g., are more likely authoritative for the knowledge domain, by classifying previously unseen websites. By using a composite-representation based upon existing website classifications the characteristics used by the classification are not limited by human discernible characteristics and can be any characteristic that can be learned by analysis of the website.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B are block diagrams of an example environment in which a system creates representations of websites.

FIG. 2 is a flow diagram of a process for classifying a website.

FIG. 3 is a block diagram of a computing system that can be used in connection with computer-implemented methods described in this document.

Like reference numbers and designations in the various drawings indicate like elements.

### DETAILED DESCRIPTION

### 1.0 Overview

A website classification system uses a composite-representation, e.g., vector, for a website classification within a particular knowledge domain, from multiple knowledge domains, to determine a classification of another website within the knowledge domain. A search system can use the website classification when generating search results in response to, or prior to, receiving a search query.

The website classifications represent categories of websites within the knowledge domain. For instance, the website classifications may include a first category of websites authored by experts in the knowledge domain, e.g., doctors, a second category of websites authored by apprentices in the knowledge domain, e.g., medical students, and a third category of websites authored by laypersons in the knowledge domain. By using a composite-representation based upon existing website classifications, the website classification is able to use characteristics learned from existing websites to classify previously unseen websites without requiring user input for the classification. By using a composite-representation based upon existing website classifications, the characteristics used by the classification are not limited by human discernible characteristics and can be any characteristic that can be learned by analysis of the website. The composite-representation may be, for example, a feature vector of features obtained from computer-based analysis of a plurality of classified websites that are automatically extracted as indicative of the classification.

The search system can use information for a search query to determine a particular website classification that is most responsive to the search query and select only search results with that particular website classification for a search results page. For example, in response to receipt of a query about a medical condition, the search system may select only websites in the first category, e.g., authored by experts, for a search results page.

The website classification system may categorize another website, e.g., a newly created website, by generating a representation of the other website and comparing the representation with the composite representation or with multiple composite representations, each for a different website classification. The website classification system may determine a composite representation that is most similar to the representation and assign the other website to the corresponding website classification.

In some implementations, when the representation does not have at least a threshold similarity to any of the composite-representations, the website classification system may determine that the other website does not belong in any of the website classifications. For instance, the website classification system may determine that the other website belongs to a new website classification.

### 1.1 Example Operating Environment

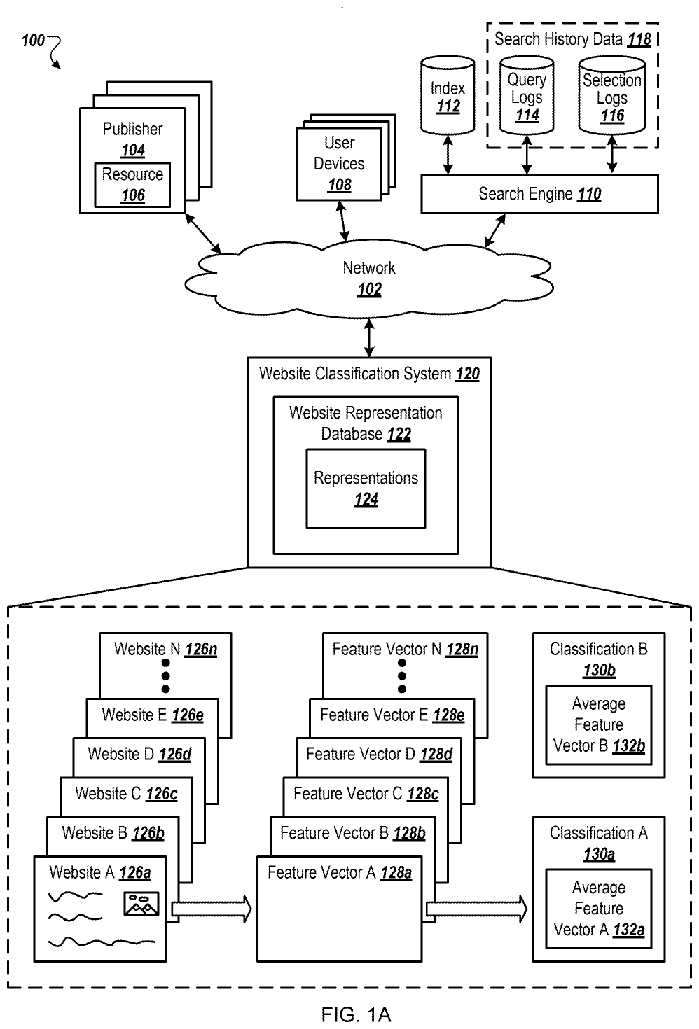

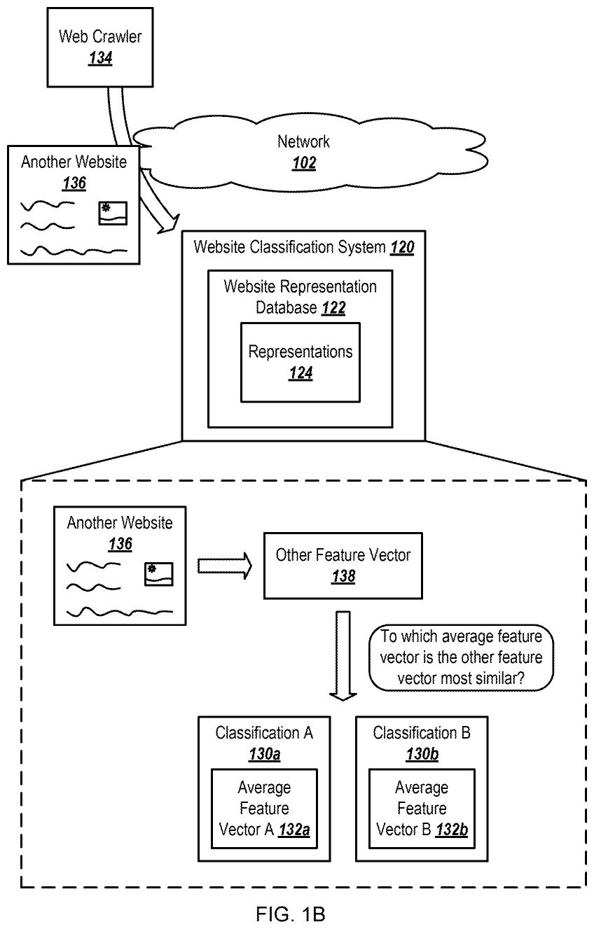

FIG. 1A is a block diagram of an example environment 100 in which a system creates representations of websites. A computer network 102, such as a local area network (LAN), wide area network (WAN), the Internet, or a combination thereof, connects publisher websites 104, user devices 108, and the search engine 110, and a website classification system 120. The online environment 100 may include many thousands of publisher websites 104 and user devices 108.

A publisher website 104 includes one or more resources 106 associated with a domain and hosted by one or more servers in one or more locations. Generally, a website is a collection of web pages formatted in hypertext markup language (HTML) that can contain text, images, multimedia content, and programming elements, for example, scripts. Each website 104 is maintained by a content publisher, which is an entity that controls, manages and/or owns the website 104.

A resource is any data that can be provided by a publisher website 104 over the network 102 and that has a resource address, e.g., a uniform resource identifier (URI). Resources may be HTML pages, electronic documents, images files, video files, audio files, and feed sources, to name just a few. The resources may include embedded information, e.g., meta information and hyperlinks, and/or embedded instructions, e.g., client-side scripts.

A user device 108 is an electronic device that is capable of requesting and receiving resources over the network 102. Example user devices 108 include personal computers (e.g., desktops or laptops), mobile communication devices (e.g., smart phones or tablets), and other devices that can send and receive data over the network 102 (e.g., televisions, and glasses or watches with network communication functionality). A user device 108 typically includes a user application, e.g., a web browser, to facilitate the sending and receiving of data over the network 102. The web browser can enable a user to display and interact with text, images, videos, music and other information typically located on a web page at a website on the world wide web or a local area network. The user device 108 may use any appropriate application to send and receive data over the network 102 and present requested resources to a user.

To facilitate searching of these resources 106, the search engine 110 identifies the resources by crawling the publisher websites 104, e.g., with a website crawler depicted in FIG. 1B, and indexes the resources provided by the publisher websites 104. Returning to FIG. 1A, data representing the indexed resources are stored in an index 112.

The user devices 108 submit search queries to the search engine 110. The search queries are submitted in the form of a search request that includes the search query and, optionally, a unique identifier that identifies the user device 108 that submits the request. The unique identifier can be data from a cookie stored at the user device, or a user account identifier if the user maintains an account with the search engine 110, or some other identifier that identifies the user device 108 or the user using the user device.

In response to the search request, the search engine 110 uses the index 112 to identify resources that are relevant to the query. The search engine 110 identifies the resources in the form of search results and returns the search results to the user device 108 in a search results resource, e.g., a search results web page. A search result is data generated by the search engine 110 that identifies a resource or provides information that satisfies a particular search query. A search result for a resource can include a web page title, a snippet of text extracted from the web page, and a resource locator for the resource, e.g., the URI of a web page or for the presentation of particular content or invocation of code for an operation in an application.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

The user devices 108 receive the search results pages and render the pages for presentation to users. In response to the user selecting a search result at a user device 108, the user device 108 stores data representing the user selection and requests the resource identified by the resource locator included in the selected search result. The publisher of the website 104 hosting the resource receives the request for the resource from the user device 108 and provides the resource to the requesting user device 108. In some examples, in response to the user selecting a search result at a user device 108, the user device 108 launches an application identified by the search result and requests a corresponding resource from the launched application, e.g., identified by a link or URI for the search result. The identified application provides the corresponding resource, e.g., a user interface with information about the corresponding resource, to the user device 108.

In some implementations, the search queries submitted from user devices 130 are stored in query logs 114. Selection data for the queries and the web pages referenced by the search results and selected by users are stored in selection logs 116. The query logs 114 and the selection logs 116 define search history data 118 that include data from and related to previous search requests associated with unique identifiers. The selection logs represent actions taken responsive to search results provided by the search engine 110. The query logs 114 and selection logs 116 can be used to map search queries submitted by user devices to resources that were identified in search results and the actions taken by users when presented with the search results in response to the queries. In some implementations, data are associated with the identifiers from the search requests so that a search history for each identifier can be accessed. The selection logs 116 and query logs 114 can thus be used by the search engine to determine the respective sequences of queries submitted by the user devices, the actions taken in response to the queries, and how often the queries have been submitted.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

### 1.2 Example System

The search engine 110 may use data from a website classification system 120 to generate search results. For instance, the website classification system 120 may generate representations for each of multiple websites A-N 126a-n and use the representations to determine a classification for each of the multiple websites A-N 126a-n. The search engine 110 may use a classification for a search query to select a category of websites with the same, or a similar, classification. The search engine 110 may determine search results from the selected category of websites.

The website classification system 120 includes a website representation database 122. The website representation database 122 can store representations 124 of the websites A-N 126a-n. The website classification system 120 may generate a feature vector A-N 128a-n for each of the websites A-N 126a-n as the representation 124 for the respective website. For instance, the feature vector A 128a can be the representation 124 of the website A 126a.

The website classification system 120 may use any appropriate method to generate the representations 124. For example, the website classification system 120 may use content from a website A 126a to generate a representation for the website A 126a. The website content may include the text from the website, the images on the website, other website content, e.g., links, or a combination of two or more of these.

The website classification system 120 uses the website content to generate a representation for the website. The website classification system 120 may use a mapping that maps the website content for the website A 126a to a vector space that identifies a representation for the website A 126a. For instance, the website classification system 120 may use a neural network, that represents the mapping, to create a feature vector A 128a that represents the website A 126a using the content of the website A 126a as input to the neural network. The neural network may be any appropriate type of neural network.

During training, the website classification system 120 may use labels for the websites A-N 126a-n to determine classifications for each of the websites A-N 126a-n. For instance, the website classification system 120 may determine a classification A 130a as a first classification and a classification B 130b as a second classification. Each of the classifications may represent a different quantity of websites. For example, the classification A 130a may include the websites A-D 126a-d and the classification B 130b may include the websites E-N 126e-n.

The labels may be any appropriate type of labels. For instance, the labels may be alphanumeric, numerical, or alphabetical characters, symbols, or a combination of two or more of these. The labels may indicate a type of entity that had the corresponding website published, e.g., a non-profit or a for-profit business. The labels may indicate an industry described on the corresponding website, e.g., artificial intelligence or education. The labels may indicate a type of person who authored the corresponding website, e.g., a doctor, a medical student, or a layperson.

In some implementations, the labels may be scores that represent a website classification. For instance, the website classification system 120 may determine to include all of the websites A-N 126a-n with a score that satisfies a first threshold, e.g., is below a first threshold, in a first category, e.g., the classification A 130a. The website classification system may determine to include all of the websites A-N 126a-n with a score that satisfies a second threshold, e.g., is greater than the second threshold, in a second category, e.g., the classification B 130b.

The scores may be specific for a particular knowledge domain. For instance, the website classification system 120 can determine multiple queries for a particular knowledge domain within a set of multiple knowledge domains. Some example knowledge domains include artificial intelligence, education, astronomy, and health. The website classification system 120 can select websites that are responsive to one of the multiple queries for the particular knowledge domain. The website classification system 120 can determine scores for the websites A-N 126a-n that are specific to the particular knowledge domain. For instance, the website A 126a may have a first score for artificial intelligence and a second score for health. These scores may represent the relevance of the respective websites to the particular knowledge domain, e.g., such that the website A 126a is more relevant to artificial intelligence than health; an authoritativeness of the respective website to the particular knowledge domain; or both. The website classification system 120 can use the selected websites responsive to the queries, e.g., the websites A-N 126a-n, to create multiple classifications, e.g., the classifications A-B 130a-b.

The website classification system 120 can identify clusters of website representations, e.g., in a multi-dimensional space, and use the clusters of website representations to determine one or more thresholds. For example, the website classification system 120 may project the website representations, e.g., feature vectors, onto a multi-dimensional space. The website classification system 120 may determine, using the projection onto the multi-dimensional space, one or more clusters of representations. The website classification system 120 may use the clusters to determine one or more thresholds that indicate values that correspond to the cluster, and a respective classification. The website classification system 120 may use the thresholds, e.g., as the first threshold and the second threshold, to assign a classification to each of the websites.

In some implementations, one or more of the websites used during training may not be assigned to a classification. For instance, when a website representation is more than a threshold distance from a cluster, or is otherwise not included in a cluster, the website classification system 120 may determine to skip using the website representation to create a composite representation, e.g., may determine to skip further analysis for the website during training.

In some examples, the classifications are for a particular knowledge domain. For instance, the website A 126a may be in a first classification for an artificial intelligence knowledge domain and a second classification for a health knowledge domain. The respective classifications may identify websites that are relevant, or not, for the respective knowledge domain. For example, the first classification may include websites, including the website A 126a, that are very relevant to the corresponding classification, e.g., artificial intelligence. The second classification may include websites, including the website E 1263, that are not very relevant to the corresponding classification, e.g., health.

In some implementations, the web site classification system 120 may determine the website classifications, e.g., the labels, while processing data for each of the websites. For instance, the website classification system 120 may determine a first cluster of websites and assign a first classification to each website in the first cluster, and determine a second cluster of websites and assign a second classification to each website in the second cluster.

The website classification system 120 may determine the classifications based on a likely responsiveness for the websites in the corresponding cluster. For example, the websites in the first cluster may have a higher likelihood of being responsive to queries in the particular knowledge domain than websites in the second cluster.

Once the website classification system 120 creates the classifications A-B 130a-b, the website classification system 120 can generate composite representations for each of the classifications 130a-b. For instance, the website classification system 120 can generate average feature vectors A-B 132a-b for the categories. The website classification system 120 can generate the average feature vectors A-B 132a-b by combining the feature vectors A-N 128a-n for the websites A-N 126a-n that are included in the respective classification A-B 130a-b. For instance, when the classification A 130a includes the websites A-D 126a-d, the website classification system 120 can combine the feature vectors A-D 128a-d to generate the average feature vector A 132a. The website classification system 120 may generate the average feature vectors A-B 132a-b by averaging, multiplying, summing, or dividing the respective feature vectors A-N 128a-n. In some examples, the website classification system 120 may select a median feature vector from those associated with a classification as the average feature vector for the classification. For instance, when the feature vector B 128b has the median value in the group of the feature vectors A-D 128a-d, the website classification system 120 may select the feature vector B 128b as the average feature vector A 132a for the classification A 130a.

The website classification system 120 may store the composite representations in the website representation database 122, e.g., as some of the representations 124. For instance, the website classification system 120 can store the composite representations in the website representation database 122 for later use classifying other websites, generating search results using the classifications, or both. The website classification system may store the average feature vectors A-B 132a-b in the website representation database 122 as the composite representations.

The website classification system 120 may store data, in the website representation database 122 or another database, that identifies the websites A-N 126a-n associated with each of the classifications A-B 130a-b. For instance, the database may include a record for each of the websites A-N 126a-n that identifies the corresponding classification A-B 130a-b for that website. The database may use any appropriate method, data, or both, to identify the websites assigned to each of the classifications A-B 130a-b.

In some examples, the website classification system 120 may store website representations, such as the feature vectors A-N 128a-n, in the website representation database 122. The website classification system 120 may use the website representations 124 in the website representation database 122 to generate updated composite representations, or to perform other website analysis.

FIG. 1B is a block diagram of the example environment 100 in which a system classifies additional websites using composite representations. For instance, during runtime, a website crawler 134 may provide the website classification system 120 with data for another website 136. The other website 136 may be a newly published website, a website the website crawler 134 recently accessed, or another website.

The website classification system 120 generates a representation for the other website 136. For example, the website classification system 120 generates the representation using the content of the website 136, such as the images, the text, other website content, or a combination of these. The representation may be another feature vector 138 for the other website 136.

In some implementations, the web site classification system 120 may generate a website representation using a portion of the content included in a website. For instance, the website classification system 120 may generate a website representation using content for a domain or subdomain of the website. When the website classification system 120 generates a representation for a particular knowledge domain, the website classification system 120 may select the domain or subdomain using the particular knowledge domain. For example, when the knowledge domain is artificial intelligence, the website classification system 120 may generate a representation for “abc.com” using content from “ai.abc.com.” When the knowledge domain is health, the website classification system may generate a representation for “abc.com” using content from “health.abc.com.” The creation of knowledge domain specific representations may enable the website classification system 120 to better classify websites, the search engine 110 to surface the most relevant search results, e.g., reducing a quantity of search results provided to a requesting device and network bandwidth consumed, or both.

In some implementations, the web site classification system 120 may include different mappings for different knowledge domains. For instance, the website classification system 120 may include a first mapping for a first knowledge domain, e.g., artificial intelligence, and a second mapping for a second knowledge domain, e.g., health. The mappings may be neural networks or models that receive data representing website content as input and provide, as output, a representation of the website, e.g., a feature vector.

The website classification system 120 may select the knowledge domains to use for website analysis based on the content included in the other website. For example, the website classification system 120 may use queries that identify responsive search results for a particular knowledge domain, e.g., “what companies are developing artificial intelligence?” When the other website 136 includes data responsive to a query for a knowledge domain, the website classification system 120 may determine to generate a knowledge domain specific representation for the other website 136, to use a knowledge domain specific mapping when generating a representation for the other website 136, or both.

The representations 124 of the websites may include about one-hundred dimensions. For instance, the representations 124 may be a compression of content representing a website that is used as input to a mapping that creates the representation. In some examples, a mapping engine, e.g., a neural network, may receive, as input, data representing the particular words included in the website. The input data may indicate a position of particular words with respect to each other, e.g., that the word “artificial” is generally near or adjacent to the word “intelligence.” The input data may indicate particular phrases included in the website. The website classification system 120 may generate the representation, e.g., the other feature vector 138, such that the representation is related to the input data, e.g., the content of the other website 136.

The website classification system 120 compares the representation of the other website 136 with the composite representations stored in the website representation database 122. For instance, the website classification system 120 may compare the other feature vector 138 with each of the average feature vectors A-B 132a-b for the classifications A-B 130a-b.

The website classification system 120 may generate, for each of the classifications A-B 130a-b, a measure of difference, or a similarity measure, that represents a similarity between the respective classification and the other website 136. For example, the similarity measure may be a scalar difference between the other feature vector 138 and the respective average feature vector A-B 132a-b. The website classification system 120 may determine the similarity measure, e.g., the scalar difference, by computing a dot product between the other feature vector 138 and each of the average feature vectors A-B 132a-b.

The website classification system 120 can use a result of the comparison to determine the classification that includes websites to which the other website 136 is most similar. For example, the website classification system 120 determines, using the similarity measure, whether the other website 136 is most similar to the websites in the classification A 130a or the classification B 130b.

The website classification system 120 may select, as the classification for the other website 136, the classification A-B 130a-b that is most similar. For instance, the website classification system 120 may select the classification A-B 130a-b with the highest similarity measure, or with the shortest distance between the other feature vector and the respective average feature vector A-B 132a-b, to name a few examples.

In some implementations, the web site classification system 120 may use a ratio between two similarity measures to select a classification for the other website 136. For instance, the website classification system 120 may calculate a ratio of a first similarity measure for the classification A 130a to a second similarity measure for the classification B 130b. When the ratio is greater than one, the website classification system 120 may select the classification A 130a for the other website. When the ratio is less than one, the website classification system 120 may select the classification B 130b for the other website. When the ratio is equal to or approximately equal to one, the website classification system 120 may determine to select another classification or to skip assigning the other website 136 to either of the classifications A-B 130a-b.

In some implementations, the web site classification system 120 may compare the similarity measure with a threshold measure when determining a classification. When the similarity measure satisfies, e.g., is greater than or equal to or either, the threshold measure, the website classification system 120 may use the corresponding classification, or the most similar classification when multiple similarity measures each satisfy the threshold measure, as the classification for the other website. When the similarity measure does not satisfy, e.g., is less than or equal to or either, the threshold measure, the website classification system 120 may determine to skip assigning the other website to the corresponding classification. For example, when the threshold measure is 0.8, and the other website 136 has similarity measures of 0.79 and 0.5 for the classifications A-B 130a-b, respectively, the website classification system 120 may determine to skip assigning either of the classifications A-B 130a-b to the other website. In this example, if the knowledge domain for the classifications A-B 130a-b is artificial intelligence, the website classification system 120 may determine that the other website 136 is not particularly relevant to artificial intelligence. The website classification system 120 may determine to create a new classification for the other website 136, may determine to skip classifying the website for the current knowledge domain, e.g., artificial intelligence, or perform another appropriate action.

The website classification system 120 can include several different functional components, including a mapping engine, e.g., a neural network classifier, a classification database, and the website representation database 122. The various functional components of the website classification system 120 may be installed on one or more computers as separate functional components or as different modules of a same functional component. For example, the mapping engine, the classification database, the website representation database 122, or two or more of these, can be implemented as computer programs installed on one or more computers in one or more locations that are coupled to each through a network. In cloud-based systems for example, these components can be implemented by individual computing nodes of a distributed computing system.

### 2.0 Example Process Flow

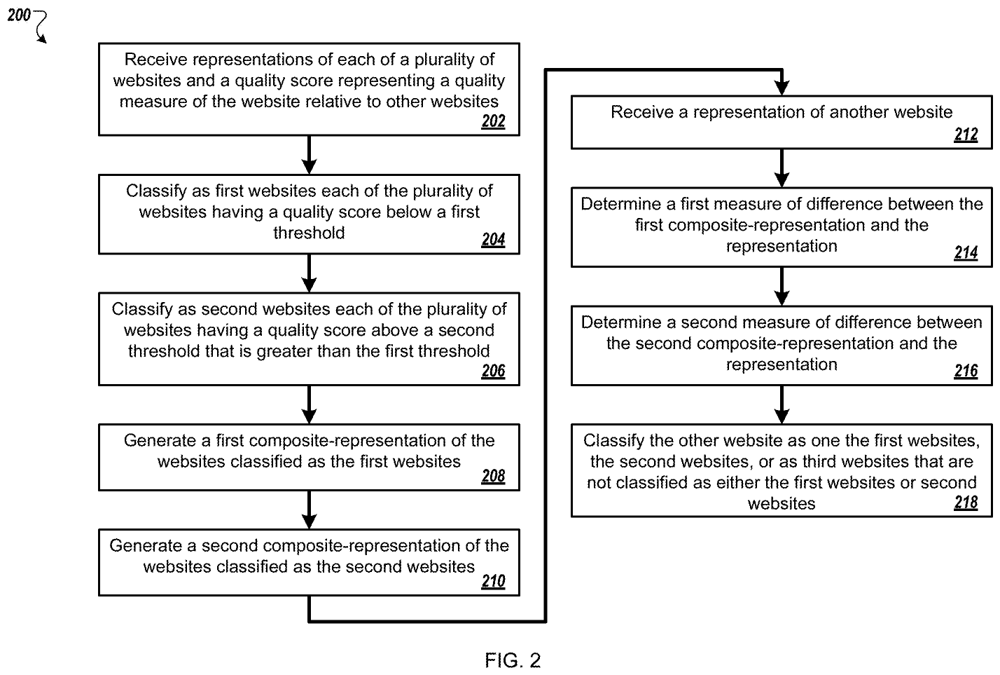

FIG. 2 is a flow diagram of a process 200 for classifying a website. For example, the process 200 can be used by the website classification system 120 from the environment 100.

A website classification system receives representations of each of a plurality of websites and a quality score representing a quality measure of the website relative to other websites (202). For example, the website classification system may generate the representations. In some examples, the website classification system may receive the representations from a memory, e.g., that implements all or part of a database.

The website classification system classifies as first websites each of the plurality of websites having a quality score below a first threshold (204). For instance, each website in the plurality of websites may have a score. The score may indicate a classification of the website, such as an authoritativeness, a responsiveness for a particular knowledge domain, another property of the website, or a combination of two or more of these.

The website classification system may use clustering to determine the first threshold. For instance, the website classification system may project the representations onto a multi-dimensional space and determine two or more clusters of the representations. The website classification system may select the first threshold as representing one of those clusters.

The website classification system classifies as second websites each of the plurality of websites having a quality score above a second threshold that is greater than the first threshold (206). For example, the website classification system may select the second threshold as representing another one of the clusters of representations in the multi-dimensional space. When the scores and thresholds relate to a property of the website, such as authoritativeness, the second threshold and the first threshold may be predetermined, may be selected based on the property, or may be selected using another appropriate selection process.

The website classification system generates a first composite-representation of the websites classified as the first websites (208). For instance, the website classification system may generate the first composite-representation using the individual representations of each of the first websites. The website classification system may create the first composite-representation by combining the representations for each of the first websites. The representations, the composite-representations, or both, may be feature vectors.

The website classification system generates a second composite-representation of the websites classified as the second websites (210). For example, the website classification system may generate the second composite-representation using the individual representations of each of the second websites. The website classification system may create the second composite-representation by combining the representations for each of the second web sites. The representations, the composite-representations, or both, may be feature vectors.

The website classification system receives a representation of another website (212). For instance, the website classification system may receive the representation from a representation generation system, implemented on one or more computers. In some examples, the website classification system may generate the representation, e.g., using one or more neural networks. The website classification system may receive the representation from a memory, e.g., that implements a database.

The website classification system determines a first measure of difference between the first composite-representation and the representation (214). For example, the website classification may determine a similarity measure that indicates a similarity between the first composite-representation and the representation. The similarity measure may indicate a distance between the representation for the other website and the first composite-representation. The website classification system may determine the similarity measure by computing a scalar value, e.g., a dot product, using the two representations.

The website classification system determines a second measure of difference between the second composite-representation and the representation (216). For instance, the website classification may determine a similarity measure that indicates a similarity between the second composite-representation and the representation. The similarity measure may indicate a distance between the representation for the other website and the second composite-representation. The website classification system may determine the similarity measure by computing a scalar value, e.g., a dot product, using the two representations.

The website classification system classifies the other website as one the first websites, the second websites, or as third websites that are not classified as either the first websites or second websites (218). The website classification system classifies the other website using the first measure of difference and the second measure of distance. For example, the website classification system determines which composite-representation is more similar to the representation of the other website and assigns the other website to the corresponding website classification, e.g., as one of the first websites or one of the second websites.

When the representation is more than a threshold distance from each of the first composite-representation and the second composite-representation, the website classification system may classify the other website as one of a group of third websites. The third websites may indicate a classification that identifies the other website as not likely relevant for the knowledge domain. The third websites may indicate a classification other than the classifications for the first websites and the second websites.

The order of steps in the process 200 described above is illustrative only, and the classification of a website can be performed in different orders. For example, the website classification system 120 may determine the second measure of difference before or concurrently with the determination of the first measure of difference.

In some implementations, the process 200 can include additional steps, fewer steps, or some of the steps can be divided into multiple steps. For example, the website classification system can perform steps 202 through 210 without performing steps 212 through 218. In some examples, the website classification system can perform steps 212 through 218 without performing some of the other steps in the process 200.

In some implementations, the web site classification system may receive data for each of a plurality of websites. The data may identify, for each of the websites, a classification for the website. For instance, each website in a first plurality of websites may have an associated first classification from a plurality of classifications and each website in a second plurality of websites may have an associated second classification from the plurality of classifications.

The data for each of the websites in the plurality of websites may be content from the corresponding website, e.g., HTML content, images, and/or other website content. In some examples, the data for each of the websites may include the words, e.g., sentences or paragraphs or both, from the websites.

The website classification system may generate composite-representations for the first and second classifications after receipt of the data for the plurality of websites. For instance, the website classification system may generate a first composite-representation for the first classification in response to receipt of the data for the first plurality of websites. The website classification system may generate a second composite-representation for the second classification in response to receipt of the data for the second plurality of websites.

As part of the process 200, a search engine may receive a query from a user device. The search engine can determine a knowledge domain that applies to the query using the query terms. The search engine may select one of the classifications for the knowledge domain upon determining that the knowledge domain applies to the query. For instance, the search engine may determine to select a particular classification, e.g., that includes the second websites, that includes websites classified as most likely responsive for the knowledge domain. The search engine may determine a subset of the websites assigned to the particular classification as responsive to the query. The search engine may select a website from the subset and provide data for the selected website to the device, e.g., as a search result. In some examples, the search engine may provide a search results page, to the device, that includes information for multiple websites from the subset of websites.

In some implementations, the search engine may reduce a quantity of websites to analyze for search results using the knowledge domain, the classifications, or both. For example, the search engine may select a group of websites for the knowledge domain upon determining that the knowledge domain applies to the query. This initial selection may discard multiple websites that the search engine does not have to analyze because each of those multiple websites were determined to not apply to the knowledge domain. The search engine may determine to search the second websites and to skip searching the first websites in response to determining that the knowledge domain applies to the query. For example, the search engine may select the second websites for searching because those websites generally have data responsive to queries for the knowledge domain while the first websites generally include data that is less responsive to queries for the knowledge domain. This process may reduce the computational resources used by the search engine to select search results, bandwidth used by the search engine to send search results to a requesting device, or both.

### 3.0 Additional Implementation Details

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HyperText Markup Language (HTML) page, to a user device, e.g., for purposes of displaying data to and receiving user input from a user interacting with the user device, which acts as a client. Data generated at the user device, e.g., a result of the user interaction, can be received from the user device at the server.

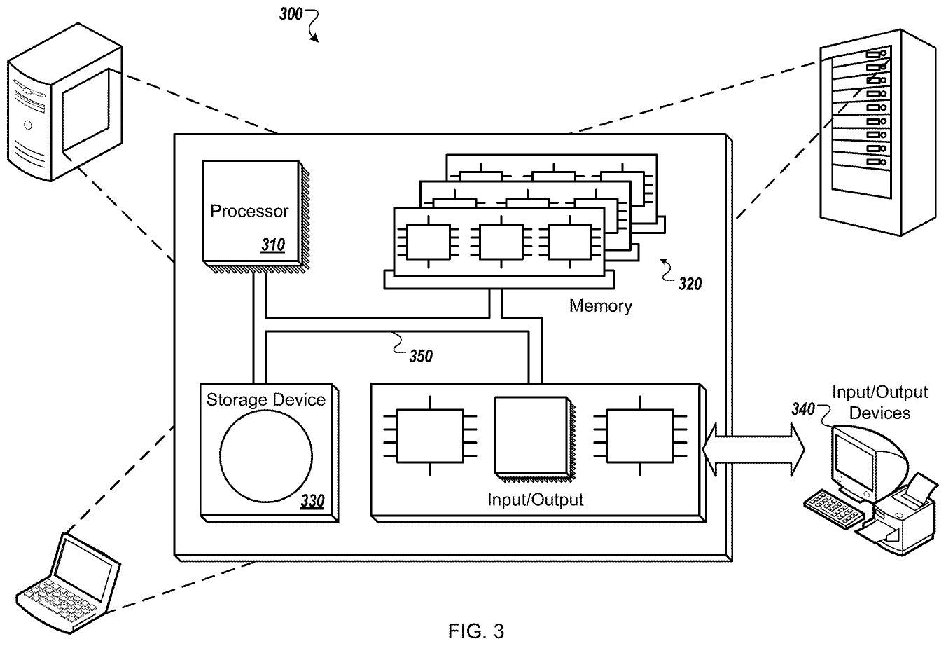

An example of one such type of computer is shown in FIG. 3, which shows a schematic diagram of a computer system 300. The system 300 can be used for the operations described in association with any of the non-conventional computer-implemented methods described previously, according to one implementation. For instance, the system 300 can receive data representing a plurality of websites and, for each of the websites, determine a classification for the website. The system 300 can use the classifications to determine groups of websites with the same classification and generate a composite-representation of the websites in the group. Each of the groups includes multiple websites, e.g., more than one. When the system 300 receives data representing a different website, the system 300 can generate a representation of the different website using the data. The system 300 compares the representation to one or more of the composite-representations. The system 300 uses a result of the comparison to determine a classification for the different website, e.g., the system 300 selects the classification that corresponds to the composite-representation that is most similar to the representation. The system 300 can use the classifications to determine search results for a query. For instance, the system 300 can select results with a classification for the query, search data for websites that have a classification for the query, or both, e.g., to reduce an amount of processing power necessary to determine results responsive to the query.

The system 300 includes a processor 310, a memory 320, a storage device 330, and an input/output device 340. Each of the components 310, 320, 330, and 340 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 may be a floppy disk device, a hard disk device, an optical disk device, or a tape device.

The input/output device 340 provides input/output operations for the system 300. In one implementation, the input/output device 340 includes a keyboard and/or pointing device. In another implementation, the input/output device 340 includes a display unit for displaying graphical user interfaces.

Embodiment 1 is a method comprising: receiving data representing each website in a first plurality of websites, each website of the first plurality of websites being associated with a first knowledge domain of a plurality of knowledge domains, each website having an associated first classification of a plurality of classifications; receiving data representing each website in a second plurality of websites, each website of the second plurality of websites being associated with the first knowledge domain, each website having an associated second classification of the plurality of classifications; generating a first composite-representation of the first plurality of websites; generating a second composite-representation of the second plurality of websites; receiving a representation of a third website; determining a first measure of difference between the first composite-representation and the representation; determining a second measure of difference between the second composite-representation and the representation; and based on the first measure of difference and the second measure of difference, classifying the third website.

Embodiment 2 is the method of embodiment 1, further comprising: generating said first and second classifications based upon respective quality scores associated with each website of the first and second plurality of websites, each quality score representing a quality measure of the respective website relative to other websites.

Embodiment 3 is the method of embodiment 2, wherein: said first and second classifications are generated based upon first and second threshold values.

Embodiment 4 is the method of any one of embodiments 1 through 3, further comprising: receiving a query that includes terms that are determined to be indicative of the particular knowledge domain, and in response: selecting one of the second plurality of websites for use in responding to the query; and responding to the query using information from the selected second website.

Embodiment 5 is the method of embodiment 4, further comprising: determining, using the terms included in the query, that the query requests responsive data from the particular knowledge domain; and in response to determining that the query requests responsive data from the particular knowledge domain, determining to search the second websites and not to search the first websites for search results responsive to the query.

Embodiment 6 is the method of any one of embodiments 1 through 5, wherein: the second plurality of websites are determined to be a collection of authoritative data sources, the method further comprising: generating, from the collection of authoritative data sources, preprocessed responses to future queries; receiving, after generating the preprocessed responses, a query that is determined to be indicative of the particular knowledge domain; and in response, responding to the query with one of the preprocessed response.

Embodiment 7 is the method of any one of embodiments 1 through 6, wherein: the data representing each website in the first and second plurality of websites comprises a feature vector derived from the corresponding web site; generating the first composite-representation comprises generating a first feature vector that is a central tendency of the feature vectors of the first plurality of websites; and generating the second composite-representation comprises generating a second feature vector that is a central tendency of the feature vectors of the second plurality of websites.

Embodiment 8 is the method of any one of embodiment 7, wherein: determining the first measure of difference comprises determining a first scalar difference between the first composite-representation and the representation of the third website; and determining the second measure of difference comprises determining a second scalar difference between the second composite-representation and the representation of the third web site.

Embodiment 9 is the method of embodiments 7, further comprising: generating each of the feature vectors using a neural network that receives, as input, content included in a corresponding website.

Embodiment 10 is the method of any one of embodiment 7, wherein: the first feature vector comprises a first feature vector that includes averages of the feature vectors of the websites classified as first websites; and the second feature vector comprises a second feature vector that includes averages of the feature vectors of the websites classified as first web sites.

Embodiment 11 is the method of any one of embodiments 1 through 10, wherein: the representations for at least some of the first and second plurality of websites are generated using only proper subsets of a set of resources that belong to the respective web site.

Embodiment 12 is a system comprising: one or more computers and one or more storage devices on which are stored instructions that are operable, when executed by the one or more computers, to cause the one or more computers to perform a method according to any of embodiments 1 through 11.

Embodiment 13 is a non-transitory computer storage medium encoded with instructions that, when executed by one or more computers, cause the one or more computers to perform a method according to any of embodiments 1 through 11.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
for each website of a plurality of websites determined to be in a particular knowledge domain, wherein the particular knowledge domain is one of a plurality of knowledge domains that are each different from the other knowledge domains:
receiving representations of the website and a quality score representing a quality measure of the website relative to other websites;
classifying as first websites each of the plurality of websites having a quality score below a first threshold, at least one of the plurality of websites having a quality score below the first threshold;
classifying as second websites each of the plurality of websites having a quality score above a second threshold that is greater than the first threshold, at least one of the plurality of websites having a quality score greater than the first threshold;
generating a first composite-representation of the websites classified as the first websites;
generating a second composite-representation of the websites classified as the second websites;
receiving a representation of another website;
determining a first measure of difference between the first composite-representation and the representation;
determining a second measure of difference between the second composite-representation and the representation; and
based on the first measure of difference and the second measure of difference, classifying the other website as one the first websites, the second websites, or as third websites that are not classified as either the first websites or second websites.

2. The method of claim 1, further comprising:
receiving a query that includes terms that are determined to be indicative of the particular knowledge domain, and in response:
selecting one of the second websites for use in responding to the query; and
responding to the query using information from the selected second website.

3. The method of claim 2, further comprising:
determining, using the terms included in the query, that the query requests responsive data from the particular knowledge domain; and
in response to determining that the query requests responsive data from the particular knowledge domain, determining to search the second websites and to skip searching the first websites for search results responsive to the query.

4. The method of claim 1, wherein the second websites are determined to be a collection of authoritative data sources, the method further comprising:
generating, from the collection of authoritative data sources, preprocessed responses to future queries;
receiving, after generating the preprocessed responses, a query that is determined to be indicative of the particular knowledge domain; and
in response, responding to the query with one of the preprocessed response.

5. The method of claim 1, wherein:
each representation of the websites comprises a feature vector derived from the corresponding website;
generating the first composite-representation of the websites classified as the first websites comprises generating a first feature vector that is a central tendency of the feature vectors of the websites classified as the first websites; and
generating the second composite-representation of the websites classified as the second websites comprises generating a second feature vector that is a central tendency of the feature vectors of the websites classified as the second websites.

6. The method of claim 5, wherein:
determining the first measure of difference comprises determining first scalar difference between the first composite-representation and the representation of the other website; and
determining the second measure of difference comprises determining second scalar difference between the second composite-representation and the representation of the other website.

7. The method of claim 5, further comprising generating each of the feature vectors using a neural network that receives, as input, content included in a corresponding website.

8. The method of claim 5, wherein:
the first feature vector that is a central tendency of the feature vectors of the websites classified as first websites comprises a first feature vector that includes averages of the feature vectors of the websites classified as first websites; and
the second feature vector that is a central tendency of the feature vectors of the websites classified as first websites comprises a second feature vector that includes averages of the feature vectors of the websites classified as first websites.

9. The method of claim 1, where the representations for at least some of the plurality of websites are generated using only proper subsets of a set of resources that belong to the respective web site.

10. A system comprising one or more computers and one or more storage devices on which are stored instructions that are operable, when executed by the one or more computers, to cause the one or more computers to perform operations comprising:
for each website of a plurality of websites determined to be in a particular knowledge domain, wherein the particular knowledge domain is one of a plurality of knowledge domains that are each different from the other knowledge domains:
receiving representations of the website and a quality score representing a quality measure of the website relative to other websites;
classifying as first websites each of the plurality of websites having a quality score below a first threshold, at least one of the plurality of websites having a quality score below the first threshold;
classifying as second websites each of the plurality of websites having a quality score above a second threshold that is greater than the first threshold, at least one of the plurality of websites having a quality score greater than the first threshold;
generating a first composite-representation of the websites classified as the first websites;
generating a second composite-representation of the websites classified as the second websites;
receiving a representation of another website;
determining a first measure of difference between the first composite-representation and the representation;
determining a second measure of difference between the second composite-representation and the representation; and
based on the first measure of difference and the second measure of difference, classifying the other website as one the first websites, the second websites, or as third websites that are not classified as either the first websites or second websites.

11. The system of claim 10, the operations further comprising:
receiving a query that includes terms that are determined to be indicative of the particular knowledge domain, and in response:
selecting one of the second websites for use in responding to the query; and
responding to the query using information from the selected second website.

12. The system of claim 11, the operations further comprising:
determining, using the terms included in the query, that the query requests responsive data from the particular knowledge domain; and
in response to determining that the query requests responsive data from the particular knowledge domain, determining to search the second websites and to skip searching the first websites for search results responsive to the query.

13. The system of claim 10, wherein the second websites are determined to be a collection of authoritative data sources, the operations further comprising:
generating, from the collection of authoritative data sources, preprocessed responses to future queries;
receiving, after generating the preprocessed responses, a query that is determined to be indicative of the particular knowledge domain; and
in response, responding to the query with one of the preprocessed response.

14. The system of claim 10, wherein:
each representation of the websites comprises a feature vector derived from the corresponding website;
generating the first composite-representation of the websites classified as the first websites comprises generating a first feature vector that is a central tendency of the feature vectors of the websites classified as the first websites; and
generating the second composite-representation of the websites classified as the second web sites comprises generating a second feature vector that is a central tendency of the feature vectors of the websites classified as the second websites.

15. The system of claim 14, wherein:
determining the first measure of difference comprises determining first scalar difference between the first composite-representation and the representation of the other web site; and
determining the second measure of difference comprises determining second scalar difference between the second composite-representation and the representation of the other web site.

16. The system of claim 14, the operations further comprising generating each of the feature vectors using a neural network that receives, as input, content included in a corresponding web site.

17. The system of claim 14, wherein:
the first feature vector that is a central tendency of the feature vectors of the websites classified as first websites comprises a first feature vector that includes averages of the feature vectors of the websites classified as first websites; and
the second feature vector that is a central tendency of the feature vectors of the websites classified as first websites comprises a second feature vector that includes averages of the feature vectors of the websites classified as first websites.

18. The system of claim 10, where the representations for at least some of the plurality of web sites are generated using only proper subsets of a set of resources that belong to the respective web site.

19. A non-transitory computer storage medium encoded with instructions that, when executed by one or more computers, cause the one or more computers to perform operations comprising:
for each website of a plurality of websites determined to be in a particular knowledge domain, wherein the particular knowledge domain is one of a plurality of knowledge domains that are each different from the other knowledge domains:
receiving representations of the website and a quality score representing a quality measure of the website relative to other websites;
classifying as first websites each of the plurality of websites having a quality score below a first threshold, at least one of the plurality of websites having a quality score below the first threshold;
classifying as second websites each of the plurality of websites having a quality score above a second threshold that is greater than the first threshold, at least one of the plurality of websites having a quality score greater than the first threshold;
generating a first composite-representation of the websites classified as the first websites;
generating a second composite-representation of the websites classified as the second websites;
receiving a representation of another website;
determining a first measure of difference between the first composite-representation and the representation;
determining a second measure of difference between the second composite-representation and the representation; and
based on the first measure of difference and the second measure of difference, classifying the other website as one the first websites, the second websites, or as third websites that are not classified as either the first websites or second websites.

20. The computer storage medium of claim 19, the operations further comprising:
receiving a query that includes terms that are determined to be indicative of the particular knowledge domain, and in response:
selecting one of the second websites for use in responding to the query; and
responding to the query using information from the selected second website.
